(19) United States
(12) Patent Application Publication
(10) Pub. No.: US 2010/0055474 A1
(43) Pub. Date: Mar. 4, 2010

(54) Silane Cross-Linking Adhesive or Sealing Compounds, Method for Producing the Same and their Use

(75) Inventors: Thomas Bachon, Duesseldorf (DE); Jennifer Schmidt, Langenfeld (DE); Thomas Tamcke, Duesseldorf (DE); Nicole Ditges, Solingen (DE); Patrick Gawlik, Langenfeld (DE)

Correspondence Address: HENKEL CORPORATION, One Henkel Way, ROCKY HILL, CT, 06067, US

(73) Assignee: Henkel Kommanditgesellschaft auf Aktien (Henkel KGaA), Duesseldorf (DE)

(21) Appl. No.: 11/993,576

(22) PCT Filed: Feb. 18, 2006
(86) PCT No.: PCT/EP2006/001486

§ 371 Date: Nov. 20, 2009

(30) Foreign Application Priority Data
Jun. 23, 2005 (DE) 10 2005 029 282.8

(51) Int. Cl. B32B 17/10; C08L 83/04; B32B 9/04; B32B 37/12

(52) U.S. Cl. 428/429; 525/477; 524/588; 428/447; 156/329

(57) ABSTRACT

The present disclosure relates to silane-crosslinking adhesives or sealants comprising a) at least one polymer of the general formula (I)

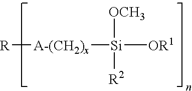

in which R is a monovalent to tetravalent hydrocarbon radical, R¹ is an alkyl radical having 1 to 8 C atoms, R² is an alkyl or alkoxy radical having 1 to 8 C atoms, and A is a carboxyl, carbamate, carbonate, ureido, urethane or sulfonate linker or an oxygen atom, x is 1 to 8, and n is 1 to 4, and b) at least one adhesion promoter, dryer and/or reactive diluent. The adhesion promoters, dryers, and/or reactive diluents are ethoxy-functional α-silanes of the general formula (II)

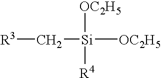

in which R³ is an organic radical attached to the methylene group via a heteroatom, and R⁴ is an alkyl radical having 1 to 8 C atoms or an ethoxy radical. The disclosure further relates to a process for producing the adhesives or sealants, and also to their use.

The present invention relates to silane-crosslinking adhesives or sealants comprising a) at least one polymer of the general formula (I)

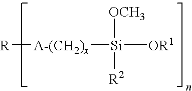

in which R is a monovalent to tetravalent hydrocarbon radical, R¹ is an alkyl radical having 1 to 8 C atoms, R² is an alkyl or alkoxy radical having 1 to 8 C atoms, and A is a carboxyl, carbamate, carbonate, ureido, urethane or sulfonate linker or an oxygen atom, x is 1 to 8, and n is 1 to 4, and b) adhesion promoters, dryers and/or reactive diluents.

Silane-crosslinking adhesives and sealants comprise alkoxysilane-terminated polymers as binders. Polymer systems which possess reactive alkoxysilyl groups have been known for a long time. In the presence of atmospheric moisture, these alkoxysilane-terminated polymers are capable even at room temperature of undergoing condensation with one another, in the course of which alkoxy groups are eliminated. Depending on the amount of alkoxysilane groups and their construction, the principal products are long-chain polymers (thermoplastics), relatively wide-meshed three-dimensional networks (elastomers) or else highly crosslinked systems (thermosets).

The polymers generally have an organic skeleton which carries alkoxysilane groups at the ends. The organic skeleton in question may for example be that of polyurethanes, polyesters, polyethers, etc.

DE 197 27 029 A1 discloses a one-component reactive-system composition which comprises an alkoxysilane-terminated polyurethane, a curing catalyst, and, if desired, typical additives.

WO 99/48942 A1 discloses alkoxysilane-terminated polyurethanes and corresponding polyurethane-containing preparations which as well as the alkoxysilylated polyurethanes can contain solvents, catalysts, plasticizers, reactive diluents, fillers, and the like.

As well as organic constituents, the polymeric skeleton may also include organosiloxane, as described in WO 96/34030 A1.

The polymers used in practice in accordance with the prior art and containing alkoxysilane end groups generally contain methoxysilane end groups. These binders are frequently used as a substitute for NCO-terminated polyurethanes and, on account of the absence of isocyanate, have distinct toxicological advantages for the user. A disadvantage, however, is the elimination of small amounts of methanol on curing.

The silane-terminated polymers that are typical at present generally contain dimethoxymethylsilyl or trimethoxysilyl end groups. Swapping the methoxy groups for ethoxy groups reduces the reactivity of the polymers to such an extent that the cure rate of the adhesives is no longer acceptable.

It is an object of the present invention to specify silane-crosslinking adhesives or sealants of the type specified at the outset with which, on the one hand, less methanol is released on curing and, on the other hand, an acceptable cure rate is achieved. Additionally it ought to be possible to control the rate of cure through the selection of the components.

Surprisingly it has been found that the aforementioned objects can be achieved through the combination of methoxysilane-terminated polymers with specific ethoxysilane-terminated additives.

The present invention accordingly provides adhesives or sealants of the type specified at the outset which are characterized in that the adhesion promoters, dryers and/or reactive diluents are ethoxy-functional α-silanes of the general formula (II)

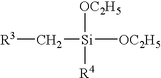

in which R³ is an organic radical attached to the methylene group via a heteroatom, and R⁴ is an alkyl radical having 1 to 8 C atoms or an ethoxy radical.

Advantageous embodiments of the invention will become apparent from the dependent claims.

The radical R³ of the general formula (II) is advantageously a methacryloyloxy radical or a carbamate radical, an amino group or an alkoxy radical. The polymeric skeleton R is a monovalent to tetravalent, preferably a divalent or trivalent, hydrocarbon radical which can contain heteroatoms and/or organosiloxane groups. Examples of the polymeric skeleton are alkyd resins, oil-modified alkyd resins, unsaturated polyesters, natural oils, e.g., linseed oil, tung oil, soybean oil, and also epoxides, polyamides, thermoplastic polyesters such as polyethylene terephthalate and polybutylene terephthalate, polycarbonates, polyethylenes, polybutylenes, polystyrenes, polypropylenes, ethylene-propylene copolymers and terpolymers, acrylates, e.g., homopolymers and copolymers of acrylic acid, acrylates, methacrylates, acrylamides, their salts, and the like, phenolic resins, polyoxymethylene homopolymers and copolymers, polyurethanes, polysulfones, polysulfide rubbers, nitrocellulose, vinyl butyrates, vinyl polymers, e.g., polymers containing vinyl chloride and/or vinyl acetate, ethylcellulose, cellulose acetates and cellulose butyrates, rayon, shellac, waxes, ethylene copolymers such as ethylene-vinyl acetate copolymers, ethylene-acrylic acid copolymers, ethylene-acrylate copolymers, for example, organic rubbers, silicone resins, and the like. Further examples include polyethers such as polyethylene oxide, polypropylene oxide, and polytetrahydrofuran. Among the stated polymeric skeletons, particular preference is given to polyethers, polyesters, and polyurethanes.

The α-silanes preferred as adhesion promoters, dryers and/or reactive diluents are selected from the group consisting of α-aminosilanes, α-methacryloylsilanes, α-carbamatosilanes, and α-alkoxysilanes. Suitable examples are N-cyclohexylaminomethylmethyldiethoxysilane, N-cyclohexyl-aminomethyltriethoxysilane, N-phenylaminomethyltriethoxysilane, (methacryl-oyloxymethyl)methyldiethoxysilane, and methacryloyloxymethyltriethoxysilane, and N-(triethoxysilylmethyl)-O-methylcarbamate and N-(methyidiethoxysilyl-methyl)-O-methylcarbamate.

Besides the polymer and the α-silane, the adhesives and sealants advantageously comprise fillers as a further ingredient. Examples of suitable fillers are chalk or finely ground lime, precipitated and/or fumed silica, zeolites, bentonites, ground minerals, and other inorganic fillers familiar to the skilled worker. Additionally it is also possible to employ organic fillers, particularly fiber wovens and the like. Certain applications prefer fillers which endow the adhesives or sealants with thixotropy, examples being swellable plastics such as PVC.

Besides the polymer and the α-silane and the fillers, the adhesives and sealants advantageously comprise further, typical additives such as plasticizers, solvents, UV stabilizers, antioxidants, catalysts, dryers, reactive diluents, and adhesion promoters.

The adhesives or sealants of the invention advantageously contain 5 to 90 parts, preferably 10 to 70 parts by weight, with particular preference 15 to 50 parts by weight of polymer a) and 0.1 to 10 parts of α-silane.

The invention also relates to a process for preparing the silane-crosslinking adhesives or sealants which is characterized in that the polymer a), the α-silanes b), and, if desired, fillers are mixed with one another. In this case advantageously 5 to 90 parts, preferably 10 to 70 parts by weight, with particular preference 15 to 50 parts by weight of polymer a) are mixed with 0.1 to 10 parts by weight of α-silane.

The invention additionally relates to the use of the adhesives of the invention for bonding wood, plastics, metals, mirrors, glass, ceramic, mineral substrates, leather, textiles, paper, board, and rubber, it being possible for the materials in each case to be bonded to themselves or arbitrarily to one another.

The invention further relates to the use of the adhesive of the invention as a reactive post-crosslinking pressure-sensitive adhesive.

The invention also relates to the use of the sealants of the invention as a sealant. The compositions of the invention can also be used with advantage as surface-coating materials, as a water vapor barrier, as a flooding compound, hole-filling compound or crack-filling compound, and for the production of moldings.

The invention is illustrated below, with reference to working examples.

### EXAMPLES

Polymer 1 (γ-triethoxysilyl-terminated polypropylene glycol):

450 g (24 mmol) of polypropylene glycol 18000 (OHN=6.1) are dried under reduced pressure at 80° C. in a 1000 ml three-neck flask. Under a nitrogen atmosphere, 0.1 g of dibutytin laurate is added at 80° C. and then 14 g (54 mmol) of isocyanatopropyltriethoxysilane (% NCO=16.1) are added. After one hour of stirring at 80° C., the resulting polymer is cooled and 9.3 g of vinyltriethoxysilane are added. The product is placed under moisture-tight storage in a nitrogen atmosphere in a glass vessel.

Polymer 2 (γ-trimethoxysilyl-terminated polypropylene glycol):

450 g (24 mmol) of polypropylene glycol 18000 (OHN=6.1) are dried under reduced pressure at 80° C. in a 1000 ml three-neck flask. Under a nitrogen atmosphere, 0.1 g of dibutytin laurate is added at 80° C. and then 11.6 g (54 mmol) of isocyanatopropyltrimethoxysilane (% NCO=19.5) are added. After one hour of stirring at 80° C., the resulting polymer is cooled and 9.3 g of α-methacryloyltriethoxysilane are added. The product is placed under moisture-tight storage in a nitrogen atmosphere in a glass vessel.

Polymer 3 (α-dimethoxymethylsilyl-terminated polypropylene glycol):

450 g (24 mmol) of polypropylene glycol 18000 (OHN=6.1) are dried under reduced pressure at 80° C. in a 1000 ml three-neck flask. Under a nitrogen atmosphere, 0.1 g of dibutytin laurate is added at 80° C. and then 9.1 g (54 mmol) of isocyanatomethyldimethoxymethylsilane (% NCO=25.0) are added. After one hour of stirring at 80° C., the resulting polymer is cooled and 9.3 g of methylcarbamatomethyltriethoxysilane are added. The product is placed under moisture-tight storage in a nitrogen atmosphere in a glass vessel.

### Polymer 4:

The polymer used as polymer 4 was Kaneka MS Polymer S 303 H, a dimethoxymethylsilyl-terminated polymer from Kaneka.

Formulation of Adhesives from Polymers 1-4:

The polymers described above were used to produce adhesive formulations. This was done by introducing polymer with plasticizer (Palatinol N: BASF) and incorporating fillers (Omyabond 302, Omya). Subsequently the remaining additives were incorporated in the order stated.

### Abbreviations:

AMMO=aminopropyltrimethoxysilane
AMEO=aminopropyltriethoxysilane
VTMO: vinyltrimethoxysilane
VTEO: vinyltriethoxysilane
DBTL: dibutyltin dilaurate
DBTAc: dibutyltin acetonate

| | Comp. 1 | Comp. 2 | Comp. 3 | Ex. 1 | Ex. 2 | Ex. 3 |
|---|---|---|---|---|---|---|
| Polymer 1 | 20% | 20% | — | — | — | — |
| Polymer 2 | — | — | 20% | 20% | — | — |
| Polymer 3 | — | — | — | — | 20% | — |
| Polymer 4 | — | — | — | — | — | 25% |
| Plasticizer | 20.8% | 20.8% | 20.8% | 20.8% | 20.8% | 15.8% |
| Fillers | 56.6% | 56.2% | 56.6% | 56.6% | 56.6% | 56.55% |
| AMMO | — | — | 0.5% | — | — | — |
| AMEO | 0.5% | 0.5% | — | 0.5% | 0.5% | 0.5% |
| VTMO | — | — | 2.0% | — | — | — |
| VTEO | 2.0% | 2.0% | — | — | — | — |
| α-Methacryloyl- | — | — | — | 2.0% | — | 2.0% |
| triethoxysilane | | | | | | |
| α-Methylcarbama- | — | — | — | — | 2.0% | — |
| totriethoxysilane | | | | | | |
| Cat. DBTL | 0.1% | 0.5% | 0.1% | 0.1% | 0.01% | — |
| Cat. DBTAc | — | — | — | — | — | 0.15% |
| Total: | 100% | 100% | 100% | 100% | 100% | 100% |
| Skinning: | >120 min | >120 min | 20 min | 60 min | 30 min | 45 min |
| Tack-free: | >24 h | >24 h | <24 h | <24 h | <16 h | <24 h |
| Visco* 1 d/RT | 33400 | 35900 | 30400 | 29800 | 31800 | 38200 |
| Visco* (4 wks/50° C.) | 34100 | 36050 | 31100 | 3100 | 33200 | 38300 |
| Tensile shear | n.d. | n.d. | 1.3 | 1.25 | 1.1 | 0.9 |
| strength** | | | | | | |
| % methanol | 0% | 0% | >2% | <0.3% | <0.2% | <0.3% |

*Viscosity: Brookfield sp. 5/50 rpm 25° C. [mPas]
**Tensile shear strength: wood/wood [N/mm²]

### Explanation/Summary:

An adhesive formulation based on γ-ethoxysilyl-terminated polypropylene glycol and ethoxysilanes is too slow (comparison 1), even with large amounts of tin catalyst (comparison 2).

An adhesive formulation based on γ-methoxysilyl-terminated polypropylene glycol and methoxysilanes (=state of the art) has good properties, but gives off >2% of methanol (comparison 3).

An adhesive formulation based on γ-methoxysilyl-terminated polypropylene glycol and ethoxysilanes has good properties, and gives off <0.3% of methanol (example 1 and 3).

An adhesive formulation based on α-methoxymethylsilyl-terminated polypropylene glycol and ethoxysilanes has good properties, contains virtually no tin catalyst, and gives off <0.2% of methanol (example 2).

1. A silane-crosslinking adhesive or sealant comprising
a) at least one polymer of the general formula (I) 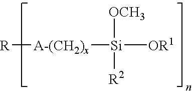
in which
R is a monovalent to tetravalent hydrocarbon radical,
R¹ is an alkyl radical having 1 to 8 C atoms,
R² is an alkyl or alkoxy radical having 1 to 8 C atoms,
A is a carboxyl, carbamate, carbonate, ureido, urethane or sulfonate linker or an oxygen atom,
x is 1 to 8,
n is 1 to 4; and
b) at least one of an adhesion promoter, a dryer or a reactive diluent, characterized in that the adhesion promoter, dryer, or reactive diluent are ethoxy-functional α-silanes of the general formula (II) 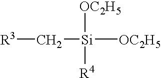
in which R³ is an organic radical attached to the methylene group via a heteroatom, and
R⁴ is an alkyl radical having 1 to 8 C atoms or an ethoxy radical.

2. The adhesive or sealant of claim 1, comprising as component a) at least one polymer of the general formula (I) 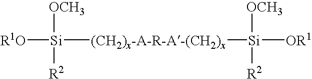
in which
R is a divalent polymeric skeleton and
A and A′ are alike or different and are a carboxyl, carbamate, carbonate, ureido, urethane or sulfonate linker or an oxygen atom.

3. The adhesive or sealant of claim 1, characterized in that R³ is a methacryloyloxy radical, a carbamate radical, an amino group or an alkoxyradical.

4. The adhesive or sealant of claim 1, characterized in that the polymeric skeleton is a polyether, polyester or polyurethane.

5. The adhesive or sealant of claim 1, characterized in that the α-silanes are selected from the group consisting of α-aminosilanes, α-methacryloylsilanes, α-carbamatosilanes, and α-alkoxysilanes.

6. The adhesive or sealant of claim 1, it further comprising at least one of fillers, plasticizers, solvents, UV stabilizers, antioxidants, catalysts, dryers, reactive diluents, and adhesion promoters.

7. The adhesive or sealant of claim 6, characterized in that it comprises 5 to 90 parts by weight of polymer a) and 0.1 to 10 parts by weight of α-silane.

8. A process for preparing silane-crosslinking adhesives or sealants, comprising
providing a) at least one polymer of the general formula (I) 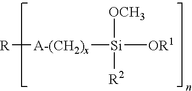
in which
R is a monovalent to tetravalent hydrocarbon radical,
R¹ is an alkyl radical having 1 to 8 C atoms,
R² is an alkyl or alkoxy radical having 1 to 8 C atoms,
A is a carboxyl, carbamate, carbonate, ureido, urethane or sulfonate linker or an oxygen atom,
x is 1 to 8,
n is 1 to 4;
providing b) α-silanes of the general formula (II) 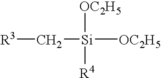
in which
R³ is an organic radical attached to the methylene group via a heteroatom, and
R⁴ is an alkyl radical having 1 to 8 C atoms or an ethoxy radical; and
mixing a) and b) with one another.

9. The process of claim 8, characterized in that component a) is a polymer of the general formula (I) 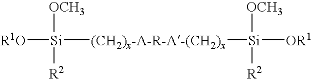
in which
R is a divalent polymeric skeleton and
A and A′ are alike or different and are a carboxyl, carbamate, carbonate, ureido, urethane or sulfonate linker or an oxygen atom.

10. The process of claim 8, characterized in that 5 to 90 parts by weight of polymer a) are mixed with 0.1 to 10 parts by weight of α-silane.

11. The adhesive of claim 1 disposed as an adhesive on a material selected from wood, plastics, metals, mirrors, glass, ceramic, mineral substrates, leather, textiles, paper, board and rubber.

12. The sealant of claim 1 disposed as a sealant on a surface to be sealed.

13. A method of using the adhesive of claim 1, comprising:
disposing the adhesive on a first surface of a part comprising a material selected from wood, plastic, metal, mirror, glass, ceramic, a mineral substrate, leather, textile, paper, board and rubber; and
bonding the first surface to a second surface of a part comprising a material selected from wood, plastic, metal, mirror, glass, ceramic, a mineral substrate, leather, textile, paper, board and rubber.

14. The method of claim 13 wherein the first and second surfaces are different portions of the same part.

15. A method of using the sealant of claim 1, comprising:
applying the sealant on a first surface to be sealed; and
disposing the first surface in sealing contact with a second surface.
